(19) United States
(12) Patent Application Publication
(10) Pub. No.: US 2005/0176508 A1
(43) Pub. Date: Aug. 11, 2005

(54) Portable entertainment colnsole

(76) Inventor: Phillip Chastain, Bogart, GA (US)

Correspondence Address: GEORGE R. REARDON, 3356 STATION COURT, LAWRENCVILLE, GA, 30044, US

(21) Appl. No.: 11/052,162

(22) Filed: Feb. 7, 2005

Related U.S. Application Data
(60) Provisional application No. 60/542,144, filed on Feb. 6, 2004.

(51) Int. Cl. G06F 19/00; G06F 17/00

(52) U.S. Cl. 463/46

(57) ABSTRACT

A portable console enabled for at least one entertainment device and having storage compartments for related entertainment accessories.

### CROSS-REFERENCE TO RELATED APPLICATIONS

This application claims priority to provisional application 60/542,144 dated Feb. 06, 2004, which is incorporated herein in its entirety.

### BACKGROUND OF THE INVENTION

The present invention relates to a console that enables the use of entertainment devices in a vehicle, with the ability to also use the device outside the vehicle.

The invention relates to the field of portable entertainment. Keeping some passengers in vehicles mentally and emotionally engaged while traveling in order to improve the quality of the travel experience for all passengers has been a long-standing problem, especially for parents traveling with their children. With the advent of lightweight entertainment devices, e.g., Sony PlayStation, Microsoft Xbox and the like, users of these devices want the convenience to use these devices at a time and place of their choosing: while traveling in a vehicle, at home, lodging away from home, etc.

While the advantages of mobile entertainment use are manifest, there are specific problems presented by introducing a portable entertainment device into a vehicular environment: (i) physical mounting and support difficulties, (ii) space limitations, (iii) power conversion problems arising from use of a vehicle battery as a power source, (iv) storage availability for entertainment accessories, (v) retaining full portability of the entertainment device for prevention of theft, and (vi) having the ability to transport the entertainment console from the vehicle into the next environment (home, hotel, boat, etc) for continued use.

Examples of attempts to provide devices for use in a vehicle for work or entertainment purposes include the following.

U.S. Pat. No. 3,917,275, issued to Alpher, pertains to a game support tray for a car passenger, having a trapezoidal base member with walled compartments along longer parallel side.

U.S. Pat. No. 4,512,503, issued to Gioso, pertains to an all purpose vehicle travel organizer, having fixed and sliding trays with openings for variety of miscellaneous items.

U.S. Pat. No. 4,813,751, issued to Fenn, pertains to a seat mounted utility console having a rectangular frame with two compartment cavities and an upstanding flange at the rear end of the frame to engage a seat.

U.S. Pat. No. 4,832,241, issued to Radcliffe, pertains to a vehicle portable-office organizer having a tray that is sized to accept an insert which can be further sub-divided by partition elements.

U.S. Pat. No. 5,338,081, issued to Young, pertains to a removable floor-mounted vehicle console having attached a small screen LCD type TV, and or VTR player which comprises a frame having a base with attached seat mounting mechanism, a storage area comprising a slide-out bin, and optional electronic entertainment unit for use by rear seat occupants.

U.S. Pat. No. 5,397,160, issued to Landry, pertains to a vehicle console for the mounting of a video unit within a passenger compartment that uses ratchet and strap assembly for providing convenient securing of console and for attaching the strap to the vehicle.

U.S. Pat. No. 5,555,491, issued to Tao, pertains to a compact docking station for a portable computer and includes upper and lower pivotable mounting brackets, between vehicle console and computer adjacent port replicating device.

U.S. Pat. No. 5,966,285, issued to Sellers, pertains to a mobile portable computer docking apparatus used in an automotive vehicle such as car, truck or a hotel room.

U.S. Pat. No. 6,305,299, issued to Ragland, pertains to a vehicular child seat tray system for facilitating feeding and entertaining a child, having a slot formed for receiving a restraining strap.

U.S. Pat. No. 6,422,440, issued to Stone, pertains to a food storage and serving device for use in vehicle, having a peripheral lip extending from bottom wall and a pair of apertures through which a seat belt for connection to vehicle seat is extended.

U.S. Pat. No. 6,435,587, issued to Flowerday, pertains to a vehicle console having an articulated cover pivotally coupled to a panel and housing to selectively move to close and to provide access to storage compartment defined in the housing.

U.S. Pat. No. 6,588,821, issued to Worrell, pertains to a multipurpose console used in a vehicle, having a lid for closing an internal compartment and which provides a surface area when upper portion of lid is moved to its lower portion.

U.S. Pat. No. Des. 243,165, issued to Sternberg, pertains to an electronic game stand.

While the above reference patents are a step in the right direction in providing a portable entertainment console, there remains room for additional improvements.

The present invention is directed toward meeting the above needs, among others.

The foregoing patents and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The present invention addresses these and other needs in the industry by providing a portable entertainment console that is enabled for use with at least one entertainment device.

In view of the foregoing, it is a principal object of the present invention to provide a portable entertainment console that allows an entertainment device to be securely supported for use within a restricted space, and which is enabled to allow for easy engagement or disengagement of the entertainment device from the portable entertainment console.

The portable entertainment console provides ample storage, both inside and outside, for various accessories and components used in game systems, gaming, and travel in general. Storage includes pockets of various types on the outside of the unit. These pockets may temporarily house such items as DVD/CD's and cases, game controllers, cables, personal items, and anything else that a game player chooses. Inside the case, there are two compartments separated by a hook and loop, e.g., Velcro, divider, for organizing and storing items. These two compartments are closed with the aid of zippers, in order to keep contents inside the portable entertainment console, as needed.

The present invention is enabled to supply power to the video game systems and to an LCD type of screen and the like. This may be accomplished by incorporating an inverter circuit that is plugged into the vehicle's power port and converts the supplied 12 volt DC into 120 volt AC. Means are provided for the purpose of restraining the portable console with a seatbelt. The portable console may have built-in storage areas for games, controllers, cables, CDs and the like. The videogame system is secured, e.g., by using a Velcro type strap, or the like, to the portable entertainment console.

The portable entertainment console may allow for rotation of the game system so that the viewing angle of the portable display is optimized for the game user. The present invention includes an AC Inverter (power supply) so that the game system can be powered and used in a vehicle with only DC power sources. For environments with AC power, the game system is powered directly by the AC power sources from that environment (e.g., buildings, condos, houses, and townhouses).

It is an object of the present invention to provide a portable entertainment console usable with a variety of power source situations that enhances entertainment device portability through the use of integrated electrical connections.

It is a further object of the present invention is to provide a portable entertainment console that is inexpensive to manufacture and simple and reliable in use.

Yet another object of the present invention is to provide a portable entertainment console which is easy to install in a vehicle such as a bench seat other than the front seat.

Another object of the present invention is to provide a support device for supporting as a unit a power supply and entertainment peripheral devices, in addition to a portable entertainment device and integrated electrical connections.

Another object of the present invention is to provide a portable entertainment console including additional devices, such as VHS, DVD, CD, GPS, etc.

Another object of the present invention is to provide a portable entertainment console that offers choices to the end user: a console version for a vehicle, e.g., a foldable, soft version.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

The above and other objects are achieved by the various aspects of the present invention, as summarized below.

### BRIEF DESCRIPTION OF THE SEVERAL VIEWS OF THE DRAWING

Other advantages and features of the invention are described with reference to exemplary embodiments, which are intended to explain and not to limit the invention, and are illustrated in the drawings in which:

FIG. 1 is a perspective view according to at least one embodiment of the present invention.

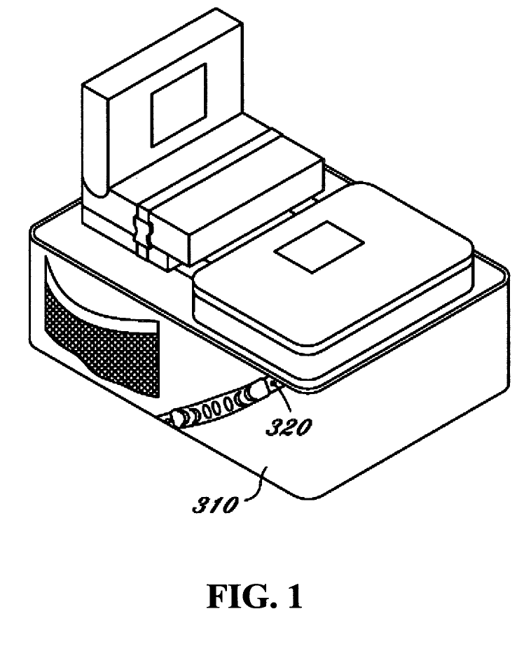

FIG. 2 is a right plan view according to at least one embodiment of the present invention.

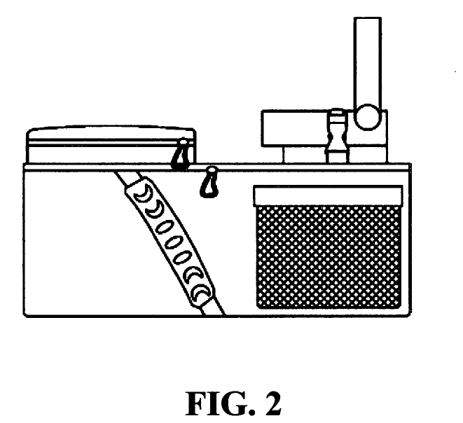

FIG. 3 is a top plan view according to at least one embodiment of the present invention.

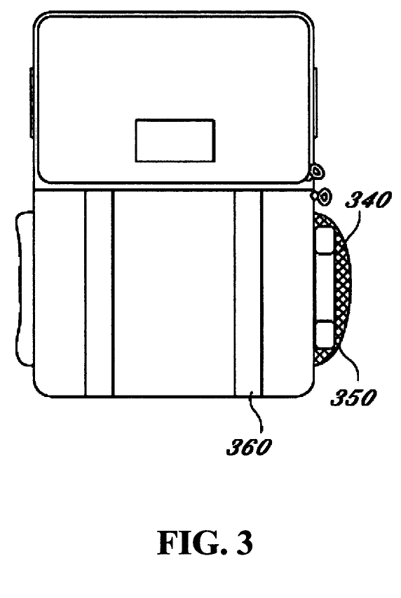

FIG. 4 is a left plan view according to at least one embodiment of the present invention.

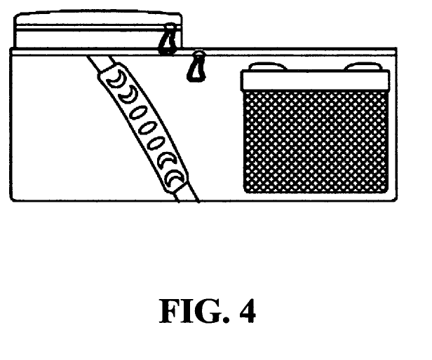

FIG. 5 is a back plan view according to at least one embodiment of the present invention.

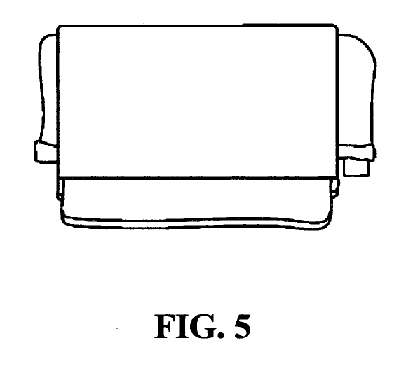

FIG. 6 is a bottom plan view according to at least one embodiment of the present invention.

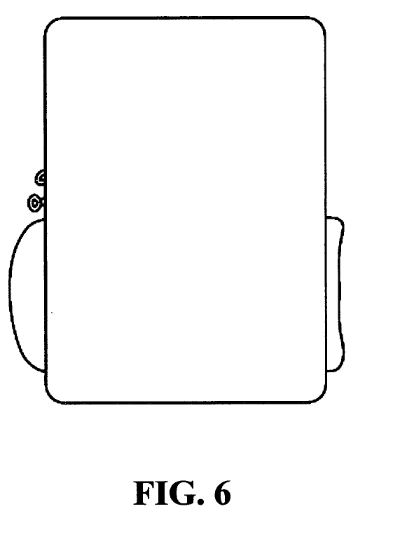

FIG. 7 is a right plan view according to at least one embodiment of the present invention.

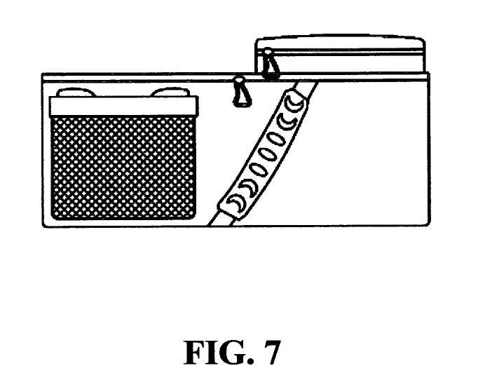

FIG. 8 is a front plan view according to at least one embodiment of the present invention.

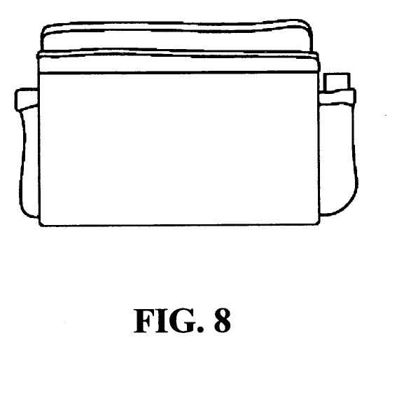

FIG. 9 is perspective view according to at least one embodiment of the present invention.

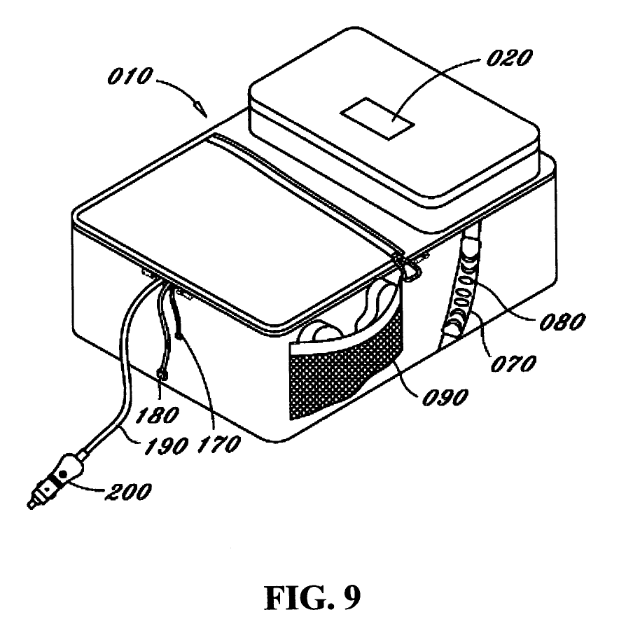

FIG. 10 is a perspective view according to at least one embodiment of the present invention.

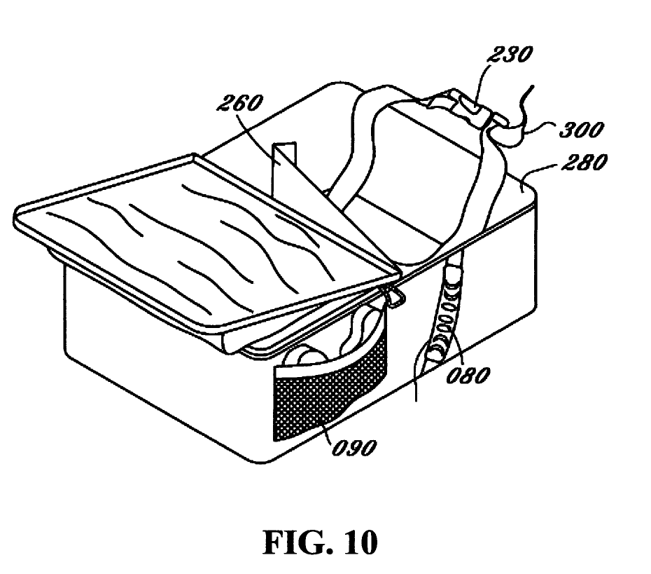

FIG. 11 is a perspective view according to at least one embodiment of the present invention.

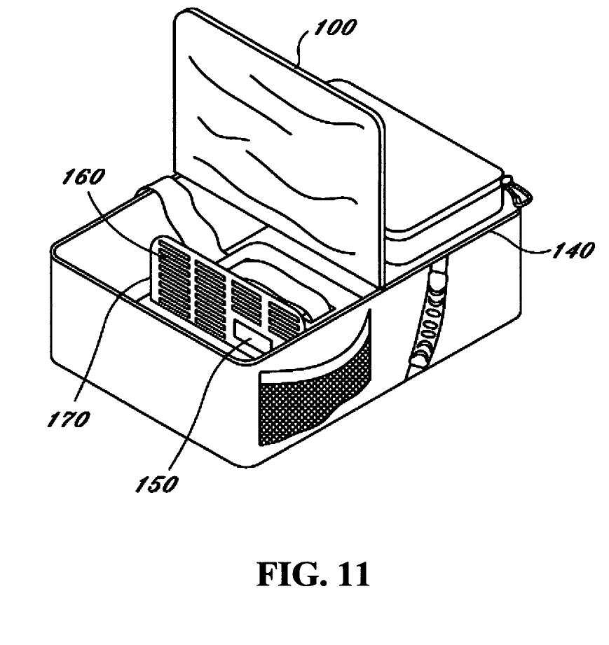

FIG. 12 is a perspective view of one of the components according to at least one embodiment of the present invention.

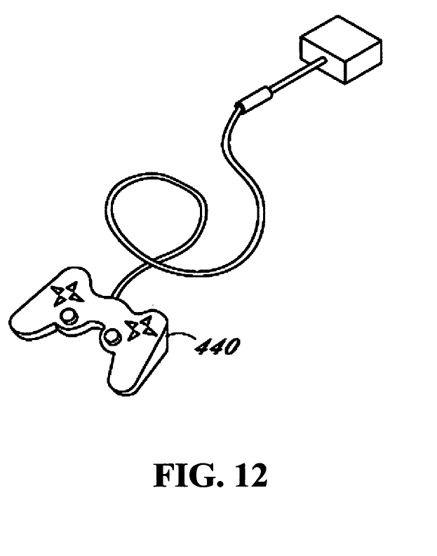

FIG. 13 is a perspective view of one of the components according to at least one embodiment of the present invention.

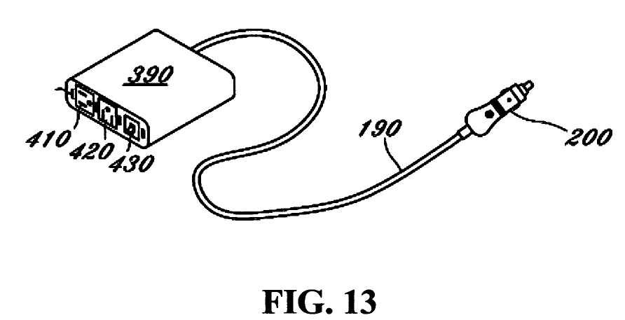

FIG. 14 is a perspective view of one of the components according to at least one embodiment of the present invention.

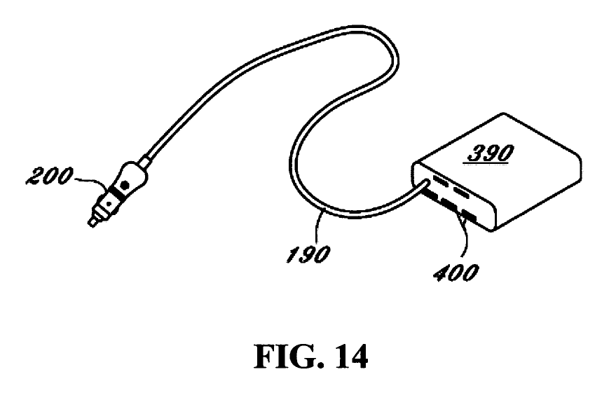

FIG. 15 is a front plan view according to at least one embodiment of the present invention.

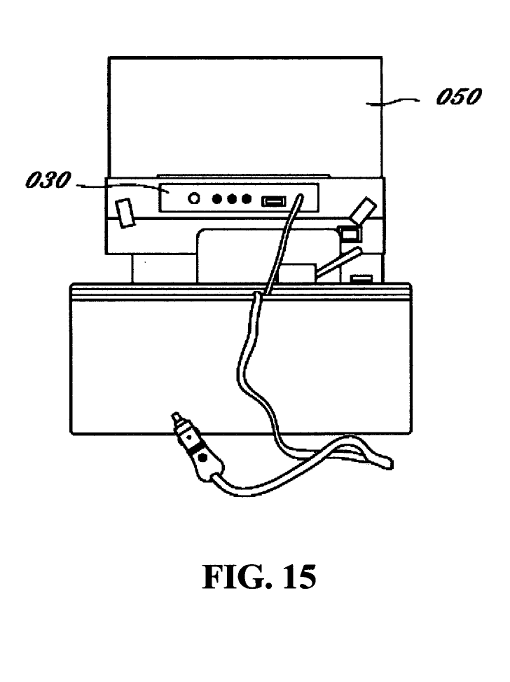

### DETAILED DESCRIPTION OF THE INVENTION

The present invention relates to portable entertainment consoles that can be safely secured in a vehicle without having to have an expensive custom installation. The present invention can be made of plastic, wood, soft fabric or other suitable material with a means of attaching various video game systems, such as, but not limited to PlayStation 2 and X-Box.

The present invention is comprised of portable console 010. The portable console 010 is further comprised of PVC plastic frame 310, top side 010T, bottom side 010B, left side 010L, right side 010R, front side 010F and back side 010BK. Right side 010R is further comprised of ergonomic seat belt restraining strap 070 and right elastic side pocket 090. Left side 010L is further comprised of ergonomic seat belt restraining strap 070 and left elastic side pocket 200. Right elastic side pocket 090 and left elastic side pocket 200 are further comprised of side pocket elastic 350, side pocket mesh 340 and reinforcement webbing 330. Top side 010T is further comprised of right security strap 110, left security strap 120, logo label 020, and media pocket 480 for holding the games, controllers and related accessories. The present invention is further comprised of game securing means, which is comprised of security bracket 170 and security strap 040. Security strap 040 is further comprised of security strap buckle 060. Security bracket 170 is further comprised of security bracket air vents 160, A/V cable cutout 150 and security bracket strap slots 130. The portable console is further comprised of first lid piping 100, second lid piping 140, large compartment lid liner 210, large compartment lid padding 220, transport strap buckle 230, compartment divider 260, nylon nylex lining 280, compartment padding 290, transport strap 300, and restraining seams 360. The compartment divider is further comprised of left divider Velcro 240, right divider Velcro 250. Ergonomic seat belt restraining strap 070 is further comprised of restrain strap rivets 320 and ergonomic retraining strap rubber 080. The present invention is further comprised of AC inverter 390, cigarette lighter plug cable 190 and cigarette lighter plug 200. The AC inverter 390 is further comprised of air vents 400, a first AC outlet 410, a second AC outlet 420, and an on/off switch 430. The present invention is further comprised of, portable display DC adapter 450. The present invention is further comprised of portable game display power plug 370, portable game display power cable 380, game system power plug and cable 170, portable game display power plug and cable 180. The present invention may be further comprised of portable display 050, controller 440 and game system 030.

In general, the preferred materials for the present invention are fabrics for the exterior and interior, webbing, zippers, rubber for handles, elastic and mesh for pockets, plastic buckles, hook & loop fasteners, e.g. Velcro, plastic for the frame, and metal rivets.

In general, construction of the present invention is accomplished as follows: fabrics, webbing, elastic, mesh, rubber handles with webbing, and zippers are sewn such that they may be installed around a plastic frame. Rivets, webbed strapping, and buckles are sewn and installed to complete the present invention.

In general, the present invention is used in conjunction with game systems, including but not limited to, Sony's PlayStation 2 and Microsoft's XBox. In many cases, users will also install a portable display on the game system. Such game systems and all their accessories and components can be placed inside the present invention and transported to and from various locations including motor vehicles, boats, airplanes, houses, condos, townhouses, buildings, and even outdoors (if there is a portable power supply to support an outdoor application). In this mode, the present invention neatly organizes many separate components for storage and transport.

A game user may then set up the game console, the game system, and all its accessories and components, such that the present invention becomes a very functional platform in its new location. For example, inside a vehicle or boat, the present invention is seat-belted onto a seat, next to the game user, so that game playing may take place with all components within reach and ready for play. When not playing in such a location, e.g., the player is resting or doing something else, all accessories and components can be neatly organized until needed later on.

A game system is secured onto the outside of the present invention, using strapping, in order to stabilize it while in a moving vehicle, boat, or airplane. Similarly, for transport, a game system is strapped securely inside the present invention so that movement is minimal. Secure strapping helps raise the level of safety in the event an accident occurs.

In the preferred embodiment of the present invention the materials used are as follows:

| | |
|---|---|
| 1 | 210D PU 59″ |
| 2 | 600D poly 58″ |
| 3 | Buckle 25 mm |
| 4 | Card Board 1200P |
| 5 | Country of Origin Label |
| 6 | Elastic Band 20 mm |
| 7 | Glue |
| 8 | Nylon Nylex 44″ |
| 9 | Nylon zipper chain #5 |
| 10 | Nylon zipper chain #8 |
| 11 | Nylon zipper slider #5 |
| 12 | Nylon zipper slider #8 |
| 13 | Packaging tape |
| 14 | PE Board 1.5 mm 31 × 54.5 cm |
| 15 | PE foam 10T |
| 16 | PE foam 6T |
| 17 | Poly Mesh 44″ |
| 18 | PP cord 4 mm |
| 19 | PP webbing 900D × 900D 23 mm |
| 20 | PP webbing double weave 12 mm |
| 21 | PP webbing double weave 20 mm |
| 22 | PP webbing 900D × 300D 23 mm |
| 23 | PP webbing double weave 25 mm |
| 24 | PVC Bar (honey-combed) 13.3 × 32.5 × 5 × 54.5 cm |
| 25 | Rubber Handle 25 mm |
| 26 | Sewing thread, polyester 30's/3 |
| 27 | Steel washer 12 mm |
| 28 | Steel wire |
| 29 | TR BOLT 10 × 13 mm |
| 30 | Velcro 25 mm (A) |
| 31 | Washer (pin-type) |
| 32 | Woven label (Game Console) |

In the preferred embodiment the above materials are used as follows:

| | | |
|---|---|---|
| 1 | 210D PU 59″ | Lining of top panel |
| | | Lining of side case |
| | | Removable divider inside |
| | | the case |
| | | Lining of bottom panel |
| 2 | 600D poly 58″ | Side panel (2 cuts) |
| | | Top panel |
| | | Top pocket |
| | | PP cord cover |
| | | Bottom panel |
| 3 | Buckle 25 mm | Movable strap on top panel |
| | | of small compartment |
| | | Strap sewn at the bottom of |
| | | the inside part of the big |
| | | compartment |
| 4 | Card Board 1200P | |
| 5 | Country of Origin Label | |
| 6 | Elastic Band 20 mm | |
| 7 | Glue | PVC frame |
| | | Removable divider |
| 8 | Nylon Nylex 44″ | PVC frame cover |
| 9 | Nylon zipper chain #5 | Top pocket |
| 10 | Nylon zipper chain #8 | Side panel |
| 11 | Nylon zipper slider #5 | Top pocket |
| 12 | Nylon zipper slider #8 | Side panel |
| 13 | Packaging tape | PVC frame |
| 14 | PE Board 1.5 mm 31 × 54.5 cm | Bottom panel |
| 15 | PE foam 10T | Top panel of small |
| | | compartment |
| | | Top panel of big |
| | | compartment |
| 16 | PE foam 6T | Bottom panel |
| | | Removable divider inside |
| | | the case |
| | | PVC frame |
| 17 | Poly Mesh 44″ | Pockets on side panel of |
| | | small compartment |
| 18 | PP cord 4 mm | Top pocket |
| | | Top panel |
| | | Bottom panel |
| 19 | PP webbing (900D × 900D) 23 mm | Seam binding of top panel |
| | | (big & small compartments) |
| | | Seam binding of bottom |
| | | panel |
| | | Seam binding of top pocket |
| 20 | PP webbing double weave 12 mm | Tape on top panel |
| | | Tape on side panel (mesh |
| | | pockets) |
| | | Loop inside small |
| | | compartment |
| 21 | PP webbing double weave 20 mm | Sewn straps on top panel of |
| | | small compartment |
| 22 | PP webbing 900D × 300D 23 mm | Rubber handles on side |
| | | panels of big compartment |
| 23 | PP webbing double weave 25 mm | Movable strap on top panel |
| | | of small compartment |
| | | Strap inside big |
| | | compartment |
| 24 | PVC Bar (honey-combed) | |
| | 13.3 × 32.5 × 5 × 54.5 cm | |
| 25 | Rubber Handle 25 mm | Side panels of big |
| | | compartment |
| 26 | Sewing thread, polyester 30's/3 | |
| 27 | Steel washer 12 mm | |
| 28 | Steel wire | |
| 29 | TR Bolt 10 × 13 mm | Frame & main case |
| 30 | Velcro 25 mm (A) | Removable divider inside |
| | | the case |
| 31 | Washer (pin-type) | |
| 32 | Woven label (Game Console) | |

The process for assembling the preferred embodiment of the present invention is as follows:

| | |
|---|---|
| PVC frame assembly | Apply glue on the surface of the |
| | PVC frame |
| | Lay flat the PE foam 6T on the |
| | frame |
| | Insert frame inside the nylon nylex |
| | cover |
| | Join open ends of PVC frame with |
| | steel wire |
| | Cover the joined ends with |
| | packaging tape |
| Top pocket - front panel | Position the woven label at the |
| | center of the upper part of the |
| | pocket's front panel |
| | Sew the edge of the label |
| | Sew the PP cord piping & the front |
| | panel together |
| | Sew one side of the zipper chain #5 |
| | to the front panel |
| Top pocket - side panel | Sew the other side of the sipper |
| | chain #5 to the side panel |
| | Join the 2 sides of the zipper chain |
| | by putting 2 pcs. S-zipper sliders |
| | Sliders should be facing each other |
| | Sew the side panel and the front |
| | panel together |
| | Cover seam with PP webbing |
| | 900D × 300D-23 mm and stitch |
| | Stitch the pocket to the top panel of |
| | the big compartment |
| Straps (20 mm) on top | Position the 2 pcs. PP webbing |
| panel of small | straps vertically with end-to-end |
| compartment | distance of 10.5″ |
| | Stitching on the webbing should |
| | measure 2″ from the top and ½″ |
| | from the bottom |
| | The un-sewn portion of the |
| | webbing is where the 25 mm |
| | movable straps will be inserted |
| Top panel | Stich together the 600D poly, PE |
| | foam 10T and lining |
| | Sew the 12 mm PP webbing tape |
| | across the top panel thereby making |
| | a dividing line between the small & |
| | big compartments |
| | Sew the PP piping all over the edge |
| | of the small & big compartments |
| Side panel | Sew the elastic band on the top |
| | edge (opening) of the poly mesh. |
| | Make 2 pcs. |
| | Put 1 poly mesh on each end of the |
| | 600D poly to make a pocket |
| | The side with the elastic band will |
| | be the mouth or opening of the |
| | pocket |
| | Insert the PP webbing 900D × 900D- |
| | 23 mm into the rubber handle. |
| | Make 2 pcs. |
| | Stitch altogether the edges of the |
| | lining, 600D poly, handle webbing |
| | & zipper chain #8 |
| | Reverse the panel inside out |
| | Join the 2 sides of the zipper chains |
| | by putting 2 pcs. Sliders. Sliders |
| | should be facing each other |
| | Put 12 mm PP webbing tape across |
| | the line dividing the small & big |
| | compartments covering one side of |
| | the mesh pocket. The tape should |
| | be aligned with the 12 mm PP |
| | webbing tape on the top panel |
| Bottom panel | Sew the 25 mm PP webbing strap to |
| | the lining |
| | Join the lining, PE foam 6T, PE |
| | board, & 600D Poly. |
| | Sew the edge |
| | Stitch the 2″ 12 mm webbing loop |
| | on the upper side of the panel |
| | Stitch the PP piping around the |
| | edge |
| | Join the side & bottom panel |
| | together & stitch |
| | Cover seam with PP webbing |
| | 900D × 300D-23 mm and stitch |
| Top panel | Sew zipper chain to the edge of the |
| | top panel |
| | Cover seam with PP webbing |
| | 900D × 300D-23 mm and stitch |
| | Reverse the case inside out |
| Frame & case assembly | Insert frame inside the case |
| | Put TR bolt/pin washer/steel washer |
| | on each side of the frame as |
| | reinforcement |
| Removable divider | Apply glue on the surface of the |
| | cardboard |
| | Lay the PE foam 6T on the |
| | cardboard |
| | Stitch the horizontal edge of the |
| | reverse side of the lining, leaving |
| | the 2 sides open |
| | Reverse the lining inside out |
| | Insert foam & cardboard inside |
| | lining cover |
| | Stitch Velcro on each side |
| Buckles | Put buckle on the webbing strap |
| | inside the case |
| | Fold end of webbing & stitch |
| | Insert the 22 mm PP webbing strap |
| | into the un-sewn part of the 20 mm |
| | webbing of the top panel |
| | Put buckle on the webbing strap |

The above-described and other features and advantages of the present invention will be appreciated and understood by those skilled in the art from the following detailed description, drawings, and appended claims.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A portable console for use inside and outside a vehicle and adapted to be removably positioned upon a vehicle seat for use inside the vehicle, said portable console comprising:
a generally hollow body having an exterior surface, said hollow body comprising
a top side, a bottom side, a left side, a right side, a front side and a back side;
said top side having a receiving area for an entertainment device; and,
a restraint means releaseably attached to said left side and said right side.

2. The portable console of claim 1, further comprising an electrical conduit means mounted in said body for connecting said entertainment device to a source of power.

3. The portable console of claim 2, further comprising an inverter circuit for converting 12 volt DC into 120 volt AC.

4. The portable console of claim 3, further comprising storage receptacles for entertainment devices related accessories.

5. The portable console of claim 4, wherein the storage receptacles have zippered closures.

6. The portable console of claim 5 wherein the storage receptacles have hook and loop closures.

7. The portable console of claim 6, wherein the receiving area is operable for horizontal rotation.

8. A portable console for use in a vehicle, comprising:
a support structure having an upper portion and a lower surface and defining an internal compartment;
a latching mechanism being fixedly secured to said lower surface of said support structure, and being configured and dimensioned to releasably engage a mounting member of the vehicle;
an entertainment device being removably secured to said upper portion, wherein said portable console provides a receiving area large enough to provide an area for seating said entertainment device; and
a retractable safety strap secured to said portable console, said retractable safety strap having a first strap portion being fixedly secured to said portable console at one end and a first connector portion at the other, said first connector portion being configured and dimensioned to engage a second connector portion secured to one end of a second strap portion having its other end secured to said portable console.

9. A portable console for use in a vehicle comprising a PVC plastic frame 310, a top side, a bottom side, a left side, a right side, a front side, a back side, game securing means, console retraining means and power means, wherein said right side is further comprised of an ergonomic seat belt restraining strap and a right elastic side pocket, wherein said left side is further comprised of an ergonomic seat belt restraining strap and left elastic side pocket 200, wherein said right elastic side pocket and left elastic side pocket are further comprised of side pocket elastic, side pocket mesh and reinforcement webbing, wherein said top side is further comprised of a right security strap, a left security strap, a logo label, and a media pocket.

10. The portable console according to claim 9, wherein said game securing means is comprised of a security bracket and security strap 040, wherein said security strap is further comprised of a security strap buckle, wherein said security bracket is further comprised of a plurality of security bracket air vents, an A/V cable cutout and security bracket strap slots.

11. The portable console according to claim 10, further comprising a transport strap.

12. The portable console according to claim 11 wherein said console retraining means is comprised of an ergonomic seat belt restraining strap further comprised of restrain strap rivets and ergonomic retraining strap rubber.

13. The portable console according to claim 12 wherein said power means is comprised of an AC inverter, a cigarette lighter plug cable and a cigarette lighter plug, wherein said AC inverter is further comprised of a plurality of air vents, a first AC outlet, a second AC outlet, and an on/off switch.

14. The portable console according to claim 12 where in said power means is a portable display DC adapter 450.

15. The portable console according to claim 13 further comprising a portable game display power plug, a portable game display power cable, a game system power plug and cable, a portable game display power plug and cable.

16. The portable console according to claim 15, further comprising a portable display, a controller and a game system.
